(19) United States
(12) Patent Application Publication
(10) Pub. No.: US 2009/0188528 A1
(43) Pub. Date: Jul. 30, 2009

(54) BI-DIRECTIONAL SCRUBBER

(76) Inventor: Mitch Junkins, Newport Beach, CA (US)

Correspondence Address: Rutan & Tucker, LLP., 611 ANTON BLVD, SUITE 1400, COSTA MESA, CA, 92626, US

(21) Appl. No.: 12/360,054

(22) Filed: Jan. 26, 2009

Related U.S. Application Data
(60) Provisional application No. 61/023,352, filed on Jan. 24, 2008.

(51) Int. Cl. A46B 13/00; B08B 1/04

(52) U.S. Cl. 134/6; 15/28

(57) ABSTRACT

An improved apparatus and method for cleaning is provided. More specifically, the improved apparatus is provided wherein the apparatus has a plurality of rotating heads whereby the heads are used to contact the body and provide cleansing pressure. Additionally, the improved apparatus and method is provided wherein the apparatus may have a plurality of rotating heads whereby the rotating heads may rotate opposite to each corresponding head wherein a first inner head may rotate clockwise while the second outer head may rotate counterclockwise. However, a first head and second head may be adjacent to one another while still rotating in a clockwise and counterclockwise direction, respectively. The contemplated embodiments of the apparatus may include a reservoir for containment of a cleansing agent that may be dispensed to the first and second head and/or directly onto the object to be cleaned whereby the cleansing agent may help facilitate cleansing of the body to be cleaned.

### PRIORITY CLAIM

The present invention claims priority to the earlier filed U.S. Provisional Patent Application No. 61/023,352 flied on Jan. 24, 2008.

### FIELD OF THE INVENTION

The field of the invention is for scrubbers. More specifically, the field of invention is for a bi-directional scrubber wherein a plurality of beads are provided that rotate counter to each other for use in cleansing.

### BACKGROUND

The history of bathing is as early as time itself. The natural odor and dirt accumulated by an individual that has not bathed is pretty evident to individuals in close proximity. Throughout history, civilizations has had different ways of taking and utilizing bathing techniques. For instance, the Romans were famous for their baths. The Romans were known for frequenting in-expensive public baths. These baths may have had attendants, lounges and other amenities.

However, just bathing whether in running or otherwise uses of water does not alone accomplish the goal of cleaning the body. For example, if an individual were to spray his/her car down with water, the act of eliminating dirt from the vehicle would not be accomplished. In fact, the vehicle would likely be as dirty after the application of water as it was before it was sprayed. In order to effectuate adequate cleaning of any article, a cleaning agent is typically used in conjunction with some sort of agitation.

Washing is typically done by the use of a liquid, a cleaning agent and/or a cleaning apparatus. It is usually an essential part of good hygiene and health. Frequently, a soap and/or detergent may be used to assist in the emulsification of dirt particles and other contaminants that may have collected on a body.

The use of a bath scrubber has been known for some time. The typical bath scrubber has a hand held portion and an abrasive portion. The bath scrubber may be held by a user and the abrasive portion is fitted against the surface of the body to be washed whereby the abrasive portion may agitate the contaminants and/or dirt particles which thereby releases the contaminants and/or dirt particles from the portions of the body to be cleansed. Other types of scrubbers eliminate the hand held portions and are commonly referred to as scrubbies. Scrubbies are essentially a ball of semi-abrasive material similar to a sponge where the scrubbie may retain some emulsification agent such as soap and the like and be used by the individual to clean the body of contaminants.

However, a problem that has presented itself is that the use of these scrubbies or hand held scrubbers requires extensive user interaction and may not adequately release dirt particles and contaminants from the body. Additionally, the bath scrubber must be used with sufficient force to dislodge the contaminants and dirty particles from the body. Often, the user does not use adequate force or is unable to do so.

Additionally, another problem that exists is that common prior art scrubbers still require a cleaning agent to be applied either separately to the body or must be applied to the cleaning apparatus such as the scrubber. No invention exists for a scrubber that may have a self contained cleaning agent enclosed therein and released upon request by the user.

A need therefore exists for an improved apparatus for cleansing wherein the improved apparatus may be automated and require less physical force by the user to operate.

### SUMMARY OF THE INVENTION

The present invention provides an improved apparatus and method for cleaning. More specifically, the present invention provides an improved apparatus having a plurality of rotating heads whereby the heads are used to contact the body and provide a cleansing pressure. Additionally, the present invention provides an improved apparatus and method wherein the apparatus may have a plurality of rotating heads whereby the rotating heads may rotate counter to each other wherein a first inner head may rotate clockwise while the second outer head may rotate counterclockwise. The contemplated embodiments of the apparatus may include a reservoir for storage of a cleansing agent that may be dispensed to the first and/or second head and whereby the cleansing agent may help facilitate the cleansing portion of the body to be cleaned.

To this end, in an exemplary embodiment of the present invention, an apparatus for cleaning an object is provided. The apparatus may have a handle portion and a head portion removably connected to the handle portion. Additionally, the apparatus has a first brush area and a second brush area wherein the first brush area is adjacent to the second brush area. Further, the apparatus may have a motor to drive the first brush area and the second brush area to rotate and/or vibrate.

In another exemplary embodiment, the apparatus has first and second brush areas that rotate counterclockwise and clockwise respective to each other.

In another exemplary embodiment, the apparatus has a motor that is powered by a power source.

In another exemplary embodiment, the apparatus has a motor that is powered by a power source wherein the power source is a battery.

In another exemplary embodiment, the apparatus has a handle portion that may have a reservoir contained therein wherein the reservoir may contain a cleansing agent.

In another exemplary embodiment, the apparatus has an on/off switch whereby the on/off switch activates and deactivates the motor.

In another exemplary embodiment, the apparatus has a first brush that may be contained at a central axis on the head portion of the apparatus and a second brush that may surround the first brush whereby the first brush rotates clockwise and the second brush rotates counterclockwise.

In another exemplary embodiment, the apparatus has a first brush that may be adjacent to a similarly situated second brush wherein the first brush rotates clockwise and the second brush rotates counterclockwise.

In another exemplary embodiment, the apparatus may be utilized to clean a human body, animal body, inanimate objects including homes, cars, boats, plastic, wood, metal and the like.

In another exemplary embodiment, the apparatus may have a reservoir wherein the reservoir contains a cleansing agent whereby the cleansing agent may be released directly onto the first brush and the second brush of the cleansing apparatus.

In another exemplary embodiment, the apparatus may have a reservoir wherein the reservoir contains a cleansing agent whereby the cleansing agent may be released directly onto the object to be cleaned.

In another exemplary embodiment, the apparatus has a first brush and a second brush that may be removed from the head of the cleaning apparatus.

In an exemplary embodiment, the apparatus has a button located thereon for activation of dispensing of a material from the reservoir.

In an exemplary embodiment of the present invention, a method for cleaning an object; the method comprising the steps of: providing a scrubber device; incorporating a head portion and a handle portion into the scrubber device; and providing a motor to drive the head portion having a plurality of brushes contained thereon.

In an exemplary embodiment, a method for cleaning an object further includes the step of allowing an individual to activate and deactivate the device.

In an exemplary embodiment, a method for cleaning an object further includes the step of activating the device whereby the brushes of the device rotate on the head of the device.

In an exemplary embodiment, a method for cleaning an object further includes the step of placing the head of the device onto a body of an object to be cleansed whereby the rotating brushes on the head of the device rotate on the surface of the object to dislodge and displace particles of dirt from the surface of the object.

In an exemplary embodiment, a method for cleaning an object is provided further including the step of: removing the head portion of the device from the handle portion of the device and adapting a second head portion having a different configuration than the first head portion and attaching the second head portion to the handle portion.

In operation, the invention may have a brush-like structure having at least a handle portion for the user to hold. Additionally, the invention may have a head portion wherein the head portion may include a brush or in an exemplary embodiment, a plurality of brushes to facilitate cleansing of the body.

In an exemplary embodiment, the present invention may be utilized to clean a human body.

In another exemplary embodiment of the present invention, the scrubber may be utilized to cleanse pets, inanimate objects including cars, boats, buildings, toys, dishes and/or any other object body that needs cleaning.

The scrubber brush may have a plurality of rotatable brushes contained thereon wherein the brushes may move in a similar and/or opposite direction from one another.

A further exemplary embodiment of the present invention may include a bi-rotational brush wherein the scrubber may have a reservoir contained therein.

In yet another exemplary embodiment of the present invention, the bi-directional scrubber brush may be operated by a small motor which may drive the scrubbers to rotate about the head.

In still another exemplary embodiment of the present invention, the bi-directional scrubber brush may be operated by a small battery powered motor which may drive the scrubbers to rotate about the head.

In a further exemplary embodiment of the present invention a bi-directional scrubber brush may be provided wherein the brush may be powered by a power source wherein the power source may be a battery.

In yet another exemplary embodiment, the present invention may include a bi-directional scrubber brush wherein the brush may have an indicator switch to show power source life left in the device.

Still another exemplary embodiment includes a bi-directional scrubber brush having a power switch wherein a user may power on the scrubber by toggling the switch, and further wherein the user may power off the device by toggling the switch.

Still another exemplary embodiment of the present invention may include a bi-directional scrubber brush wherein the scrubber may have a reservoir contained therein wherein the reservoir may have a cleansing agent contained therein for disbursement to the body of an individual or disbursed onto the brush of the scrubber apparatus itself.

Yet another exemplary embodiment of the present invention may include a bi-directional scrubber brush wherein the brush may have a first position wherein a first brush head may be centralized on the head of the brush and a second brush head may be peripheral to the first brush head and may rotate about the first brush head.

In an exemplary embodiment of the present invention a bi-directional scrubber brush may be provided wherein the brush may have a first brush head that may be centralized on the head of the brush and a second brush head that may be positioned peripheral to the first brush wherein the first brush may rotate in a clockwise direction and the second brush head may rotate in a counterclockwise direction.

Another exemplary embodiment of the present invention may include a bi-directional scrubber having a plurality of scrubbers and a reservoir for containing and releasing a cleansing agent.

In practice, an individual wishing to clean themselves, or any other object that they may desire to be cleaned with, may utilize the scrubber wherein the user may grip the scrubber, turn the device on using a switch and the action of the dual scrubbers to rotate on the object to be cleaned. The scrubber movement on the object may loosen dirt particles to be swept away in the eventual rinse.

Additionally, in an exemplary embodiment of the present invention, a bi-directional scrubber may be provided wherein the first head may be surrounded by a second head wherein the first head and the second head rotate in opposite directions.

Still, in another exemplary embodiment of the present invention, a bi-directional scrubber may be provided wherein a first head may be in position above a second head wherein the first head and second head may be adjacent to one another and further wherein the first and second heads move in opposite directions from one another.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a perspective view of the invention illustrating the apparatus in an exemplary embodiment of the present invention;

FIG. 2 is a top view of the invention illustrating the apparatus in an exemplary embodiment of the present invention;

FIG. 3 is a view of the plurality of brush portions in an exemplary embodiment of the present invention;

FIG. 4 is a view of the handle portion in an exemplary embodiment of the present invention; and

FIG. 5 is a perspective view of the invention illustrating the device in an exemplary embodiment of the present invention.

### DETAILED DESCRIPTION OF THE PREFERRED EMBODIMENT

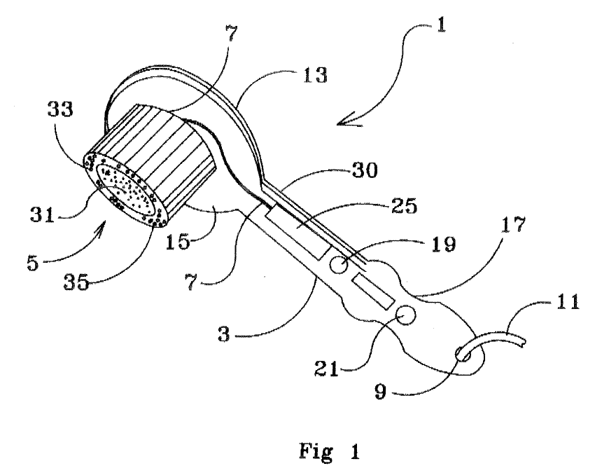

Referring now to the drawings were like numerals are used to described similar components, a bi-directional scrubber brush 1 is illustrated. FIG. 1 illustrates the scrubber brush 1 in an exemplary embodiment of the present invention. It should be understood that many other exemplary embodiments have been contemplated, but for ease of illustration and description, the presented exemplary embodiment is herein discussed.

FIG. 1 illustrates a perspective view of the brush 1 whereby the brush has at least a handle portion 3 and a brush portion 5. The handle portion 3 may be integrally constructed in association with the brush portion 5. However, it is contemplated that the handle portion 3 may be a removable attachment to the brush portion 5 at an attachment point 7. The advantage of having the handle portion 3 be a removable attachment to the brush portion 5 is in the ability to change configurations and uses of the type of brush portion 5 utilized. For example, a larger brush portion 5 may be contemplated, or a brush portion 5 that may rotate in a different manner may be provided which may change the purpose and use of the brush 1.

Further illustrated on the handle portion 3 of the brush 1 is an opening 9 thereon whereby the opening 9 may be adaptable to hang the entire brush 1 unit from some type of hook and/or loop (not shown). Further, the opening 9 may be adaptable to accommodate a loop 11 made of any suitable material such that the loop 11 may be utilized around the wrist of the individual user of the brush 1. The loop 11 may also be utilized to store and/or hang the brush 1 by utilizing the loop about a storage device (not shown). Further, it is contemplated that the handle portion 3 has at least an outside surface 13 and an inside surface 15. The outside surface 13 may have a plurality of grooves 17 thereon for adaptability of the surface 13 to an individual user's hands (not shown). Moreover, the outside surface 13 may be constructed of any suitable material that may be waterproof or disallow water absorption into the inside surface 15 of the handle portion 3. In an exemplary embodiment, the outside surface 13 and the inside surface may be fabricated from plastic. However, it is contemplated that any other suitable material may be used to manufacture the handle portion 3. Additionally, a button 19 may be provided on the outside surface 15 of the handle whereby the button 19 may be utilized by an individual user to activate the brush portion 5 of the device. The button 19 may also be depressed to deactivate the brush portion 5 of the device. It is further contemplated that a second button 21 may also be provided whereby the second button 21 may also be provided on the outside surface 13 of the device 1. The second button 21 may be attached to a reservoir 25 of the interior portion 27 of the device 1. The reservoir 25 may be located at the upper portion 30 of the handle portion 3. Furthers as described earlier, the handle portion 3 may be a removable attachment to the brush portion 5. When the handle portion 3 is not attached to the brush portion 5, the reservoir 25 is accessible to the user such that the user may fill the reservoir with the desired liquid, such as soap, detergent, bath wash, body wash, shampoo, conditioner, lotion mid the like.

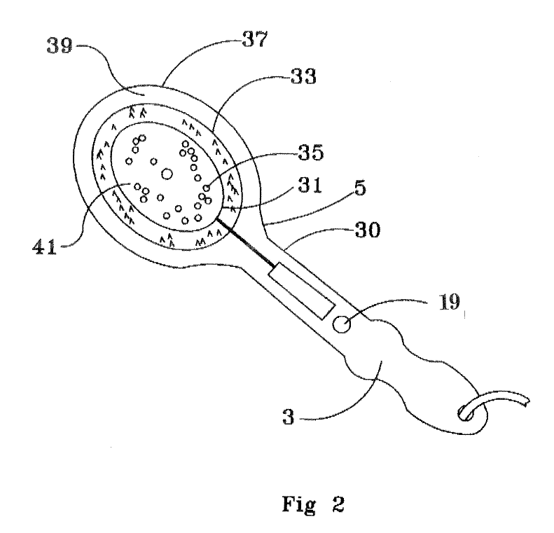

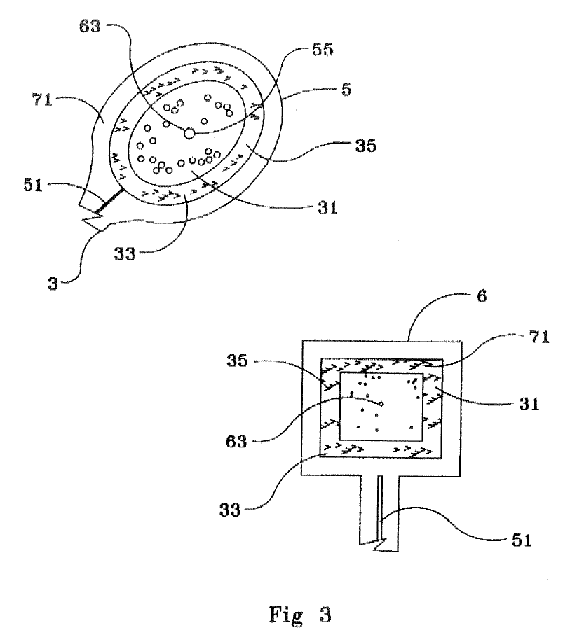

FIGS. 1 and 2 further illustrates the head and/or brush portion 5 of the device 1. As illustrated, the brush portion 5 may have at least a first inner area 31 and a second outer area 33. The first inner area 31 may have a plurality of bristles 35 thereon and the second outer area 33 may also have a plurality of bristles 35 located thereon. FIG. 2 further illustrates that the plurality of bristles 35 on the first inner area 31 may be attached to a generally planar, and circular surface 37 which incorporates much of the interior area 39 of the brush portion 5. The second outer area 33 may also have a plurality of bristles 35 that are located on a generally planar and circular surface 41 whereby the surface substantially surrounds the first inner area 31. The bristles 35 contained on the first inner area 31 may be sized, weighted and shaped either substantially the same as the bristles 35 contained on the second outer area 33. It is, however, contemplated that the bristles 35 contained on the second outer area 33 may be larger, or, in an exemplary embodiment, of a higher density and coarseness than the bristles 35 contained on the first inner area 31. Moreover, it is contemplated that the bristles 35 contained on the first inner area 31 may be thinner and less dense than the bristles 35 contained on the outer area 33. Still further, it is contemplated that the first inner area 31 may contain material other than bristles including sponge like materials, rubber materials, mesh materials such as those found in prior art body scrubbers and the like. Further, it is contemplated that either the first inner area 31 or the second outer area 33 may be comprised of a massaging material such as rubberized components to massage an area of an individual user while the other corresponding area, either the first inner area 31 or the second outer area 33 is comprised of typical bristles 35. This is further illustrated in FIG. 3 whereby a brush portion 5 is further illustrated.

FIG. 3 further illustrates the removability of the brush portion 5 from the handle portion. Additionally, as illustrated, a plurality of brush portions 5 may be provided whereby the brush portion 5 may be removed from the handle portion 3 and replaced with a second brush portion 6 which may be adapted to fit about the handle portion 3. In an exemplary embodiment, the second brush portion 6 may be utilized by a different user in the same household, or may have different purposes including massage, harder or softer bristles 35 and other components thereon. The adaptability of a plurality of brush portions 5 may extend and increase the usability and adaptability of the device 1.

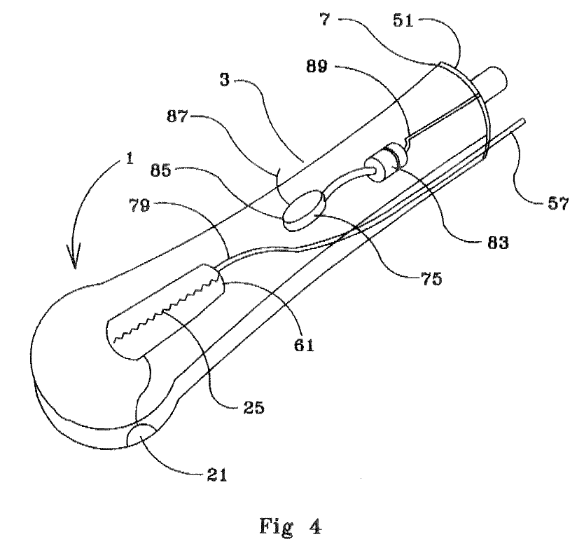

Further illustrated in FIGS. 1-3, the brush portion 5 may have an opening 51 from a first end 53 of the brush 5 extending to the midpoint 55 of the brush portion 5. The opening 51 accommodates and lines up with a corresponding opening 57 on the handle portion 3 which is further illustrated in FIG. 4. The opening 51 allows for movement of a liquid from a reservoir found on the handle portion 3. The opening 51 continues in a substantially hollow cylinder 61 which extends from the first end 53 of the brush portion 5 to the midpoint 55 and terminates at a second valve opening 63 on the exterior portion 71 of the brush portion 5. The valve opening 63 allows for release of the liquid when desired by the individual user. It is contemplated that the liquid could be any of a plurality of desirable substances including soap, shampoo, lotions, conditioners, body wash, detergents, health and beauty products, cleaning products, coloring products and the like. It should be understood that any of a plurality of different products may be dispensed by the device 1 depending on the desires and needs of the individual user. For example, an individual that desires to use the device for cleaning the body may utilize a soap or body wash in the reservoir and allow for dispensing of the soap or body wash when desired and during cleaning of the body. However, another individual may utilize the same device 1 for use with washing a vehicle, whereby the device 1 may have a vehicle wash detergent found within the reservoir and the individual user may dispense the detergent when desired. Further, it is contemplated that the reservoir may have household products contained therein such as a cleaning supply which would allow the individual user to utilize the brush bristles 35 to clean a surface, fixture or the like and at the same time utilize the cleaning solutions contained within the reservoir. Other practical applications have been contemplated such as paint for painting a wall, fixture or other device. It should be understood by a person of ordinary skill in the art, that the practical applications embodied by the present invention are great and the device 1 is not limited to a singular use.

FIG. 4 illustrates the handle portion 3 of the device 1. As illustrated above, the handle portion may have an opening 57 which is the terminating end of a substantially hollow cylindrical line 75 which extends from the opening 57 to the reservoir 25 contained within the interior portion of the handle portion 3. The reservoir 25 may be of any suitable size and dimension needed to hold the substance therein including those illustrated above. Further, a button 21 may be attached to the reservoir 25 whereby when depressed, the button sends a signal to the reservoir to release a quantity of the substance contained within the reservoir 25. In an exemplary embodiment, a valve 79 may be contained on the terminal end of the cylindrical line 75 closest to the reservoir 25. The valve 79 may be programmed to allow only a certain amount of the substance contained within the reservoir 25 to be released from within. This may ensure that only a precise amount of the substance is released and the reservoir capacity is properly utilized by the individual user.

FIG. 4 further illustrates the power mechanism 81 which allows for rotation and vibration of the inner and outer areas 31, 33 of the brush portion 5. The power mechanism 81 may be a small electric motor 83 which is powered by a power supply 85 which may be in the form of a battery 87. The power mechanism 81 powers the rotation and/or vibration of a axle 89 which rotates either the first inner area 31 or the second outer area 33. It is contemplated that the first area 31 rotates in one direction, while the second outer area 33 rotates in an opposite direction from the first inner area 31. In an exemplary embodiment, the first inner area 31 may rotate clockwise, while the second outer area 33 may rotate counterclockwise. However, it is further contemplated that the rotations may be the same in either the clockwise direction or the counterclockwise direction depending on the desires of the individual user. It is further contemplated that the individual user may change the settings on the device 1 to allow for rotation in either direction for either of the first inner area 31 or the second outer area 33.

In an exemplary embodiment, it is contemplated that the first inner area 31 and the second outer area 33 do not rotate at all, but rather the power mechanism 81 provides vibration to the first inner area 31 and the second outer area 33 whereby the two areas may vibrate in tandem or may vibrate at different frequencies such that the first inner area 31 may vibrate to a lower frequency and the second outer area 33 may vibrate to a high frequency thereby slower or speeding the movement of the bristles 35 contained thereon. However, it should be understood that the vibratory frequency may be adjusted by the user depending on their desired use of the device 1.

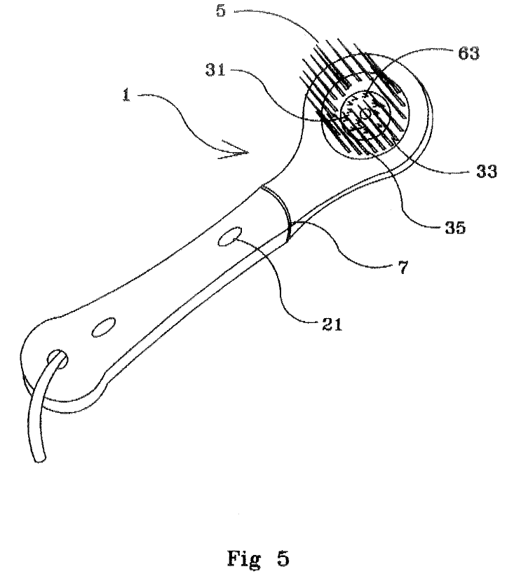

FIG. 5 illustrates the device 1 in use. As illustrated, a button 21 may be utilized by the individual user to activate the rotation and/or vibration of the first inner area 31 and the second outer area 33. As seen in the figure, it is contemplated that the rotation and/or vibration be contradictory to one another. For example, as illustrated, the inner area 31 is rotating and/or vibrating in a counterclockwise fashion whereby the outer area 33 is rotating and/or vibrating in a clockwise fashion. Further, another button may be provided which allows for release of a substance from the reservoir 25 which is expelled from the device 1 at the opening 63 on the brush portion 5 of the device. The opening 63 may be contained within the bristles 35 of the brush portion 5 whereby the substance released from the opening 63 may come in contact with the bristles 35 and may further be enabled to coat at least a portion of the bristles 35 in the same manner that an individual user may use a bottle to coat a device used for cleansing and the like. In this way, the individual user may control the amount of substance released by depressing the button a plurality of times to increase the substance released and may facilitate easier coating of the bristles 35 because of the agitation of the rotating and vibrating first inner area 31 and second outer area 33 which may better facilitate spreading of the substances released from within the reservoir 25.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

Thus, specific embodiments and applications of modular overhead storage have been disclosed. It should be apparent, however, to those skilled in the art that many more modifications besides those already described are possible without departing from the inventive concepts herein. The Inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a nonexclusive manner, indicating that the referenced elements, components, or steps may be present, or utilized, or combined with other elements, components, or steps that are not expressly referenced. Where the specification claims refer to at least one of something selected from the group consisting of A, B, C, . . . and N, the text should be interpreted as requiring only one element from the group, not A plus N, or B plus N, etc.

I claim:

1. An apparatus for cleaning an object, the apparatus comprising:
a handle portion;
a head portion removably connected to the handle portion;
a first inner brush area and a second outer brush area wherein the first brush area is adjacent to the second brush area; mid
a power mechanism which drives the first brush and the second brush to rotate and vibrate.

2. The apparatus described in claim 1 wherein said first and second brush areas rotate counterclockwise and clockwise respective to each other.

3. The apparatus described in claim 1 wherein said motor is powered by a power source.

4. The apparatus described in claim 1 wherein said motor is powered by a power source wherein the power source is a battery.

5. The apparatus described in claim 1 wherein said handle portion may have a reservoir contained therein wherein the reservoir may contain a cleansing substance.

6. The apparatus described in claim 1 wherein said apparatus has an on/off switch whereby the on/off switch activates and deactivates the motor.

7. The apparatus described in claim 1 wherein the apparatus has a button located thereon for activation of dispensing of a material from the reservoir.

8. The apparatus described in claim 1 wherein said first brush area may be contained at a more central axis on the head portion of the apparatus and the second brush area may surround the first brush whereby the first brush area rotates clockwise and the second brush area rotates counterclockwise.

9. The apparatus described in claim 1 wherein the first brush area may be adjacent to a similarly situated second brush area wherein said first brush area rotates clockwise and said second brush area rotates counterclockwise.

10. The apparatus described in claim 1 wherein the cleaning apparatus may be utilized to clean a human body, animal body, inanimate objects including homes, cars, boats, plastic, wood, metal and the like.

11. The apparatus described in claim 1 wherein the cleaning apparatus may have a reservoir wherein the reservoir contains a cleaning agent whereby the cleaning agent may be released directly onto the first brush and the second brush of the cleaning apparatus.

12. The apparatus as described in claim 1 wherein said apparatus may have a reservoir wherein the reservoir contains a cleaning agent whereby the cleaning agent may be released directly onto the object to be cleaned.

13. The apparatus as describe in claim 1 wherein the first brush area and the second brush area are contained on the brush portion of the apparatus whereby the brush portion may be removed and replaced by another subsequent brush portion onto the handle portion.

14. A method for cleaning an object; the method comprising the steps of:
providing a scrubber device;
incorporating a head portion and a handle portion removably attached to one another into the scrubber device; and
providing a motor to drive the head portion having a plurality of brushes contained thereon.

15. The method of claim 14 further comprising the step of:
activating the device whereby the brushes of the device rotate on the head of the device.

16. The method of claim 14 further comprising the step of:
placing the head of the device onto a body of an object to be cleansed whereby the rotating brushes on the head of the device rotate about surface of the object to dislodge and displace particles of dirt from the surface of the object.

17. The method of claim 14 further comprising the step of:
removing the head portion of the device from the handle portion of the device and adapting a second head portion having a different configuration than the first head portion and attaching the second head portion to the handle portion.
